(19) United States
(12) Patent Application Publication
(10) Pub. No.: US 2008/0190728 A1
(43) Pub. Date: Aug. 14, 2008

(54) ONE-WAY CLUTCH

(75) Inventors: Hiroki SEGAWA, Fukuroi-shi (JP); Hirofumi Ogata, Kakegawa-shi (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 12/023,007

(22) Filed: Jan. 30, 2008

(30) Foreign Application Priority Data
Feb. 9, 2007 (JP) 2007-030852

(51) Int. Cl. F16D 41/07

(52) U.S. Cl. 192/41 A

(57) ABSTRACT

In a one-way clutch, an inner diameter-side retainer is formed with a radially inward flange while an outer diameter-side retainer is formed with a radially outward flange. The inner race has a portion radially outwardly extended from one end in the axial direction to the more outer diameter side than the outer race. The outer race has a portion radially inwardly extended from one end on the axially opposite side to that of the inner race to the more inner diameter side than the inner race. Those extended portions face each other in the axial direction with the torque transmitting members therebetween. The inner diameter-side retainer engages the inner race on the side of the extended portion of the inner race at the inner periphery of the inward flange, and the outer diameter-side retainer engages the outer race on the side of the extended portion of the outer race at the outer periphery of the outward flange.

This application claims the benefit of Japanese Patent Application No. 2007-030852 which is hereby incorporated by reference.

### BACKGROUND OF THE INVENTION

1. Field of the Invention

The present invention relates to improvement in a one-way clutch that is used in an automatic transmission of a vehicle, or the like, and to improvement in a one-way clutch for a starter used in a starting system of an internal combustion engine.

2. Related Background Art

In an automatic transmission of a vehicle or the like, there is used a one-way clutch for transmitting a rotating force on the driving side only in one direction, and not in a reverse direction.

FIG. 2 is a cross-sectional view showing a structure of a conventional one-way clutch of a sprag type in a transverse direction to an axial direction. The one-way clutch is comprised of an inner race 10 and an outer race 11 which are coaxially provided to rotate relative to each other, and a one-way clutch mechanism 15 which is interposed between the inner race 10 and the outer race 11. The one-way clutch mechanism 15 is comprised of a plurality of sprags 12 each serving as a torque transmitting member, a spring member 14 for urging the sprags 12 in the direction of engagement, an inner diameter-side retainer 20 and an outer diameter-side retainer 21 both in cylindrical forms for retaining the sprags 12 and, at the same time, suppressing excessive inclination thereof, and a pair of end bearings (not shown) for retaining both retainers with a predetermined gap therebetween to secure the action of the springs 12.

One end of the inner diameter-side retainer 20 in the axial direction constitutes an inward flange (not shown) inwardly provided toward the inside in the radial direction. When the inner peripheral side of the inward flange is engaged with the outer peripheral surface of the inner race 10, the inner diameter-side retainer 20 is positioned and the one-way clutch is centered.

Also, one end of the outer diameter-side retainer 21 in the axial direction constitutes an outward flange (not shown) outwardly provided toward the outside in the radial direction. When the outward flange is engaged with the inner peripheral surface of the outer race 11, the outer diameter-side retainer 21 is positioned.

When the inner race 10 is rotated in one direction, the sprags 12 are inclined in the direction of engagement in accordance with a rotation of the inner race 10, and when cam surfaces 12a of the sprags 12 are engaged with an inner peripheral surface 11a of the outer race 11 and an outer peripheral surface 10a of the inner race 10, the sprags are meshed with the outer race 10 and the outer race 11. With this arrangement, a rotating force of the inner race 10 is transmitted to the outer race 11 through the sprags 12, and the outer race 11 is rotated in the same direction as the inner race 10.

On the other hand, when the outer race 11 is rotated in the reverse direction, the cam surfaces 12a of the sprags 12 fall in a non-engaged state with the inner peripheral surface 11a of the outer race 11 and the outer peripheral surface 10a of the inner race 10, so that the outer race 11 runs idle. Thus, only one directional rotation of the inner race 10 is transmitted.

Further, a one-way clutch in which a one-way clutch mechanism is combined with a rolling bearing is used in order to cope with high-speed relative rotation between the inner race and the outer race (Refer to Japanese Patent Application Laid-Open No. 2003-90360).

In addition, Japanese Utility Model Application Laid-Open No. 60-56832 discloses a structure for preventing removal of a retainer in the axial direction in a one-way clutch without using a removal-preventing plate.

In assembling the retainers in the conventional one-way clutch, in the case where both the outward flange of the outer diameter-side retainer and the inward flange of the inner diameter-side retainer are provided on the same end side in the axial direction of the one-way clutch, since the inward flange has a centering function, if the inward flange of the inner diameter-side retainer which is fitted on the inner race is positioned to be superposed on a chamfered portion of the outer peripheral surface of the inner race in the axial direction, there arises a problem that the centering function can not be secured.

In order to avoid such a problem, it is inevitable to widen the width of the inner race in the axial direction to the extent that the inward flange of the inner diameter-side retainer and the chamfered portion of the outer peripheral surface of the inner race are not superposed each other in the axial direction, or reduce the width of the sprag and that of the inner diameter-side retainer in the axial direction without changing the width of the inner race in the axial direction, so as to prevent the superposition of the inward flange of the inner diameter-side retainer and the chamfered portion of the outer peripheral surface of the inner race in the axial direction.

However, if the width of the inner face in the axial direction is widened, the width of the whole clutch in the axial direction is also widened. On the other hand, if the width of the sprag is reduced, the torque capacity is decreased. Further, an automatic transmission to be incorporated in a vehicle may be designed to have a saved space for installation of a clutch, or the like, which serves as a power transmitting device in the axial direction, in order to reduce the width of the automatic transmission in the axial direction. In such a case, since a space for installation in the axial direction is small, it becomes difficult to incorporate the power transmitting device in the automatic transmission. For this reason, a raceway member of the power transmitting device is inevitably formed to match the installation space.

### SUMMARY OF THE INVENTION

Accordingly, in view of the above-described problems, an object of the present invention is to provide a one-way clutch which can be assembled in a limited axial width to contribute to space saving without reducing a torque capacity and damaging a function of the one-way clutch, so as to attain an ideal positional relation between the retainers.

In order to solve the above problems, there is provided, according to the present invention, a one-way clutch comprising: an inner race and an outer race which are coaxially provided to be rotatable relatively to each other; a plurality of torque transmitting members interposed between an outer peripheral raceway of the inner race and an inner peripheral raceway of the outer race; and an inner diameter-side retainer and an outer diameter-side retainer both having cylindrical forms for retaining the torque transmitting members at predetermined intervals in the circumferential direction and suppressing an inclination thereof, one end of the inner diameter-side retainer being formed with an inward flange in the radial direction while one end of the outer diameter-side retainer being formed with an outward flange in the radial direction, which one-way clutch being characterized in that: the inner race has a portion which is outwardly extended in the radial direction from one end thereof in the axial direction to the more outer diameter side than the outer race; the outer race has a portion inwardly extended in the radial direction from one end thereof which is on the opposite side to the one end of the inner race in the axial direction to the more inner diameter side than the inner race; the extended portion of the inner race and the extended portion of the outer race are disposed to face each other in the axial direction with the torque transmitting members therebetween; the inner diameter-side retainer is engaged with the inner race on the side of the extended portion of the inner race at the inner periphery of the inward flange; and the outer diameter-side retainer is engaged with the outer race on the side of the extended portion of the outer race at the outer periphery of the outward flange.

In the one-way clutch according to the present invention, it is preferable that a recessive part is provided in an engagement portion of an inner peripheral raceway of the outer race with the outer periphery of the outward flange in the entire circumferential direction, and that an outer peripheral portion of the outward flange is caught in the recessive part.

According to a one-way clutch of the present invention, it is possible to save a space in the axial dimension so as to assemble a clutch mechanism within the limited axial width. It is also possible to attain an ideal positional relationship between the retainers while securing a torque capacity and a function of the one-way clutch.

Further, it is possible to prevent a removal of the outer diameter-side retainer in the axial direction by providing the recessive part in the engagement portion of the inner peripheral raceway of the outer race with the outer periphery of the outward flange of the outer diameter-side retainer and making the outer periphery of the outward flange caught in this recessive part.

### BRIEF DESCRIPTION OF THE DRAWINGS

FIG. 1 is a cross-sectional view in the radial direction of the essential part of a one-way clutch according to an embodiment of the present invention.

FIG. 2 is a cross-sectional view in a transverse direction to the axial direction showing a structure of a conventional one-way clutch.

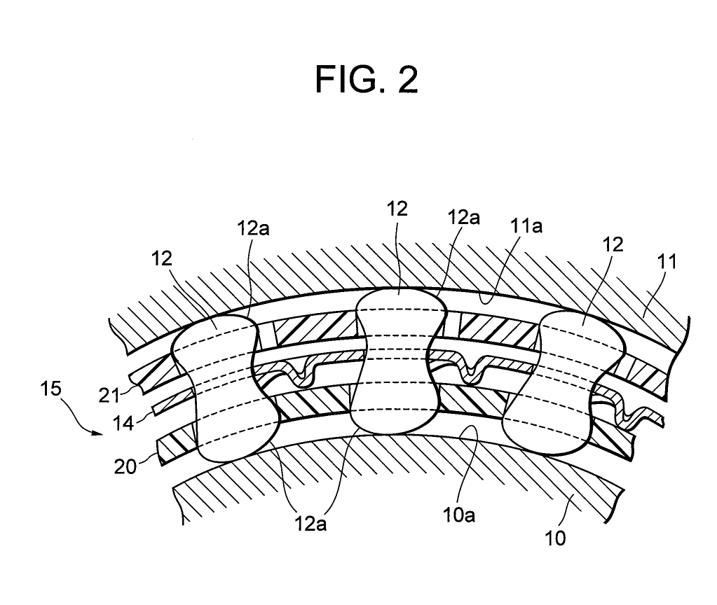

### DESCRIPTION OF THE PREFERRED EMBODIMENT

Now detailed description will be made on a one-way clutch according to an embodiment of the present invention, with reference to the drawings. It is needless to say that the embodiment described below is to only exemplify the present invention and not to limit it.

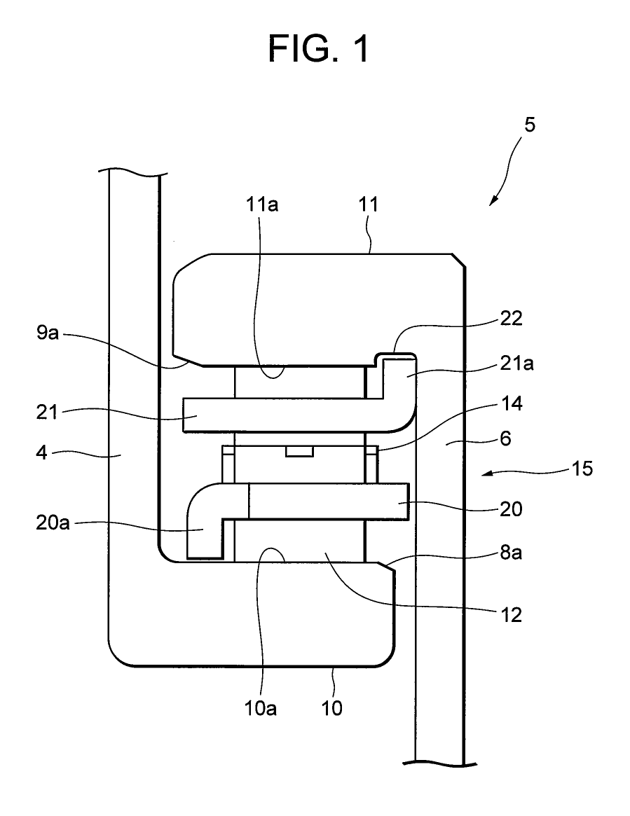

A one-way clutch 5 according to the present embodiment will be described in detail with reference to FIG. 1. FIG. 1 is a cross-sectional view of the essential part of the one-way clutch 5 according to the present embodiment.

A one-way clutch mechanism 15 is provided with a plurality of sprags 12 which are interposed between an inner race 10 and an outer race 11, a spring member 14 for retaining the sprags 12 and, at the same time, for urging the sprags 12 in the direction of engagement, and an inner diameter-side retainer 20 on the inner race side and an outer diameter-side retainer 21 on the outer race side both for suppressing an excessive inclination of the sprags 12. The inner race 10 has an extended portion 4 which is extended outwardly in the radial direction from one end in the axial direction more to the outer diameter side than the outer race 11 (hereinafter called the inner race member outwardly extended portion 4). The outer race 11 has an extended portion 6 which is extended inwardly in the radial direction from an end in the axial direction on the opposite side to the inner race member outwardly extended portion 4 more to the inner diameter side than the inner race 10 (hereinafter called the outer race member inwardly extended portion 6). An outer peripheral raceway 10a of the inner race 10 has a chamfered part 8a at the tip thereof on the side of the outer race member inwardly extended portion 6, while an inner peripheral raceway 11a of the outer race 11 has a chamfered part 9a at the tip thereof on the side of the inner race member outwardly extended portion 4.

In the present embodiment, the inner race member outwardly extended portion 4 is integrally formed with a rotating member for output of an unillustrated driving side mechanism, while the outer race member inwardly extended portion 6 is integrally formed with a rotating member for input of an unillustrated driven side mechanism.

Thus, the inner race 10 is integrated with the rotating member for output of the driving side mechanism in the inner race member outwardly extended portion 4 which is extended outwardly in the radial direction from an end on the opposite side to the outer race member inwardly extended portion 6 in the axial direction, and the outer race 11 is integrated with the rotating member for input of the driven side mechanism in the outer race member inwardly extended portion 6 which is extended inwardly in the radial direction from an end on the opposite side to the inner race member outwardly extended portion 4 in the axial direction. These two races 10 and 11 constitute the one-way clutch 15 between the outer peripheral raceway 10a of the inner race 10 and the inner peripheral raceway 11a of the outer race 11 which are provided coaxially to face each other in the radial direction.

Because of the above-described structure, a rotation of the rotating member for output of the driving side mechanism becomes a rotation of the inner race as it is, and is transmitted to the outer race 11 through the sprags 12 serving as the torque transmitting members of the one-way clutch mechanism 15. Then, a rotation of the outer race 11 becomes a rotation of the rotating member for input of the driven side mechanism as it is. Thus, a rotation of the driving side mechanism is transmitted to the driven side mechanism. On the other hand, a rotation of the outer race 11 is not transmitted to the inner race 10 by the one-way clutch 15.

Next, the configurations of the inner diameter-side retainer 20 and the outer diameter-side retainer 21, and assembling of these two retainers will be described.

The inner diameter-side retainer 20 and the outer diameter-side retainer 21 are cylindrical, and a plurality of unillustrated windows for retaining the sprags 12 are provided in each of the cylindrical portions. One end of the inner diameter-side retainer 20 in the axial direction is formed with an inward flange 20a in the radial direction. A flange 21a provided outwardly in the radial direction is formed on an end of the outer diameter-side retainer 21 in the axial direction and on the opposite side to the inward flange 21a.

An inner periphery of the inward flange 20a is engaged with the outer peripheral raceway 10a of the inner race 10, so as to position the inner diameter-side retainer 20, whereby centering is executed. With such an engagement, the inner diameter-side retainer 20 can be disposed at a position where an end portion of the inward flange 20a and the chamfered portion 8a at the tip end of the inner race 10 are not superposed on each other in the axial direction, whereby the centering function of the inner diameter-side retainer 20 can be secured without fail.

The outer periphery of the outward flange 21a is engaged with the inner peripheral raceway 11a of the outer race 11 on the side of the outer race member inwardly extended portion 6 in the axial direction of the inner peripheral raceway 11a of the outer race 11, so as to position the outer diameter-side retainer 21. With such an engagement, the outer diameter-side retainer 21 is disposed at a position where an end of the outward flange 21a is not superposed on the chamfered portion 9a at the tip end of the outer race 11 in the axial direction.

In the one-way clutch 5 arranged as described above, the inner race 10 has the inner race member outwardly extended portion 4 at one end thereof in the axial direction, and the outer race 11 has the outer member inwardly extended portion 6 at one end thereof on the opposite side to the inner race member outwardly extended portion 4 of the inner race 10. The inner race 10 and the outer race 11 are disposed to face each other in the axial direction with the clutch mechanism 15 therebetween, the inner diameter-side retainer 20 is engaged with the inner race 10 on the side of the inner race member outwardly extended portion 4 of the inner race 10 at the inner periphery of the inward flange 20a, and the outer diameter-side retainer 21 is engaged with the outer race 11 on the side of the outer race member inwardly extended portion 6 of the outer race 11 at the outer periphery of the outward flange 21a, whereby the retainers can be disposed at the positions where the flanges 20a, 21a of the retainers 20, 21 are not superposed on the chamfered portions 8a, 9a of the inner race 10a and the outer race 11 in the axial direction and a space in the axial dimension of the one-way clutch 5 can be saved. It is also possible to bring the retainers to the ideal positions without damaging the torque capacity and the function.

Also, in the present embodiment, a recessive part 22 is provided in an engagement portion of the inner peripheral raceway 11a with the outer periphery of the outward flange 21a in the entire circumferential direction. The outward flange 21a of the outer diameter-side retainer 21 is caught in the recessive part 22. With such an arrangement, it is possible to prevent a removal of the one-way clutch mechanism 15 in the axial direction.

As described above, by using a one-way clutch according to the present invention, it is rendered possible to assemble the one-way clutch within the limited axial width without damaging the torque capacity and the function, thereby contributing to space saving.

Note that a one-way clutch according to the present invention is not limited to the foregoing embodiments, but can be changed in various manners.

What is claimed is:

1. A one-way clutch comprising:
an inner race and an outer race coaxially provided to be rotatable relatively to each other;
a plurality of torque transmitting members interposed between an outer peripheral raceway of said inner race and an inner peripheral raceway of said outer race; and
an inner diameter-side retainer and an outer diameter-side retainer both having cylindrical forms for retaining said torque transmitting members at predetermined intervals in the circumferential direction and suppressing an inclination thereof, one end of said inner diameter-side retainer being formed with an inward flange in the radial direction while one end of said outer diameter-side retainer being formed with an outward flange in the radial direction,
which one-way clutch being characterized in that:
said inner race has a portion which is outwardly extended in the radial direction from one end thereof in the axial direction to the more outer diameter side than said outer race;
said outer race has a portion which is inwardly extended in the radial direction from one end thereof which is on the opposite side to said one end of said inner race in the axial direction to the more inner diameter side than said inner race;
said extended portion of said inner race and said extended portion of said outer race are disposed to face each other in the axial direction with said torque transmitting members therebetween;
said inner diameter-side retainer is engaged with said inner race on the side of said extended portion of said inner race at the inner periphery of said inward flange; and
said outer diameter-side retainer is engaged with said outer race on the side of said extended portion of said outer race at the outer periphery of said outward flange.

2. A one-way clutch according to claim 1, wherein a recessive part is provided in an engagement portion of an inner peripheral raceway of said outer race with the outer periphery of said outward flange in the entire circumferential direction, and an outer peripheral portion of said outward flange is caught in said recessive part.
